(19) United States
(12) Patent Application Publication
(10) Pub. No.: US 2003/0208529 A1
(43) Pub. Date: Nov. 6, 2003

(54) System for and method of real-time remote access and manipulation of data

(76) Inventors: Sreenath Pendyala, Saratoga, CA (US); Jean-Sebastien Pierre Riehl, San Francisco, CA (US)

Correspondence Address: HEWLETT-PACKARD COMPANY, Intellectual Property Administration, P.O. Box 272400, Fort Collins, CO, 80527-2400, US

(21) Appl. No.: 10/138,357

(22) Filed: May 3, 2002

(51) Int. Cl. G06F 15/16

(52) U.S. Cl. 709/203

(57) ABSTRACT

Disclosed is a system for providing access to computer resources from a light client including a host computer platform including (i) an application program configured to interact with a user to provide displayable results and (ii) a host routine configured to interface the application program to a communications link; and a server including (i) a remote routine configured to interactively interface with the host routine on the communications link to provide remote access to the application program, and (ii) a remote access hosting routine configured to provide the displayable results in a form displayable by said light client and to retransmit commands from the user to the application program via the remote routine.

### FIELD OF THE INVENTION

The present invention relates generally to the real-time access and management of data and more specifically to remote access to host computer programs, processing and information between a portable device and a host computer.

### BACKGROUND OF THE INVENTION

The proliferation of mobile and portable computing and the introduction of digital assistants and similar devices makes it possible for people to work away from their offices while being supported by computer resources necessary to accomplish required tasks. In addition to portable computing facilities, increasingly workstations are networked together with commonly accessible data managed by a system of network based servers. In both cases, it is often desirable to synchronize information between devices (e.g., handheld device, workstation, and/or server) to keep information current. Further, it is often desirable to utilize resources such as specialized computer programs that may not be loaded onto a local device, such as a specialized database management system, spreadsheet, accounting or other software. Further, even when suitable software may be provided on a local device, the data requirements for a particular application may be excessive and therefore unavailable or not fully available to a user. (Note, as used herein the terms “local” and “remote” are used for purposes of convenient reference only, “local” referring to computer resources facilities employed by a user attempting to gain remote access to a host computer platform at a location “remote” to the user).

To partially meet the needs of a user of a local device, various software programs and systems have been developed to provide remote access to remote computer facilities. See, for example, U.S. Pat. No. 5,831,639 incorporated herein by reference in its entirety. Commercial products providing remote access include PCANYWHERE® by Symantec; LAPLINK® by Traveling Software, Inc.; REACHOUT® by Stac Software, Inc.; MICROCOM® by Compaq Computer Corp.; CARBON COPY™ by Altiris, Inc.; TIMBUKTU PRO® by Netopia; Control IT by Computer Associates Think, Inc. (replacement for REMOTELY POSSIBLE® by Avalan Technology, Inc.); PROCOMM RAPID REMOTE™ from Quarterdeck Corp.; COSESSION REMOTE® by Artisoft Inc., and Virtual Network Computing (VNC) by AT&T Research Labs. Such remote access software allows the user to run applications and work on documents remotely. The user can control the remote host computer, located at home or at work for example, substantially as though sitting right in front of it by installing appropriate software on both the remote host and local computers, logging into a suitable communications network, and accessing the remote host PC with a local terminal.

While such remote control software is helpful, there are several limitations. For example, the user must load the remote control software on both the local and remote host systems. Often, loading such software and using it to access information on the host or elsewhere on the network is difficult for a user to accomplish. Further, if access is to a proprietary file format, such as a MICROSOFT® WORD® file, the user may be required to have the appropriate application (in this case MICROSOFT® WORD®) installed on the local device to access the data on the remote host computer and process it. This is particularly true in a situation with embedded information. Furthermore, file transfer requires large bandwidth and download time. Often, bandwidth is at a premium so that download of application files requires an inordinate amount of time as does the time to make changes to the file and upload it back onto the remote host computer. Such applications are further often user unfriendly. Most importantly, remotely accessing information over a slow or congested network (e.g., the Internet) makes accessing the application further difficult.

Accordingly, a need exists for an improved and robust remote control system for providing remote access to computer resources, including programs and data resident on a host platform.

### SUMMARY OF THE INVENTION

An embodiment of the present invention is directed to a system for providing access to computer resources from a light client, the system including a host computer platform including (i) an application program configured to interact with a user to provide displayable results and (ii) a host routine configured to interface the application program to a communications link; a server including (i) a remote routine configured to interactively interface with the host routine on the communications link to provide remote access to the application program, and (ii) a remote access hosting routine configured to provide the displayable results in a form displayable by said light client and to retransmit commands from the user to the application program via the remote routine.

An embodiment of the present invention is also directed to a method of providing remote access to computer resources from a light client including the steps of receiving a command from a light client for execution of a host application program; executing the host application program to provide displayable results; interfacing the host application program to a communications link; transmitting the displayable results to an intermediate network node; reformatting the displayable results into a target format; and retransmitting the displayable results in the target format to said local device.

### BRIEF DESCRIPTION OF THE DRAWINGS

FIG. 1 is a diagram of a system according to a preferred embodiment of the present invention;

FIG. 2 is a diagram of a system according to an embodiment of the present invention including detailed block diagrams of functional aspects thereof;

FIG. 3 is a front view of a handheld displaying a preferred embodiment remote window of the present invention; and

FIG. 4 is a flowchart of a method according to a preferred embodiment of the present invention.

### DETAILED DESCRIPTION OF PREFERRED EMBODIMENT

In one embodiment the present invention enables a local user to access, coordinate with, modify, and/or update computer files and programs stored on a remote computer system without requiring the local user to pre-install coordinating software on the local device. In this embodiment, the local user accesses the remote resources via for example an intranet, and a real time interactive service network manages the coordination between the local device and the remote system. The coordination may include for example, providing conversion between display formats, such as to facilitate an application native display output to be displayed on an HTML web page, and input/output, such as to facilitate use of a different input device and/or a different input format than is native to an application program, for a specific application program on the remote system.

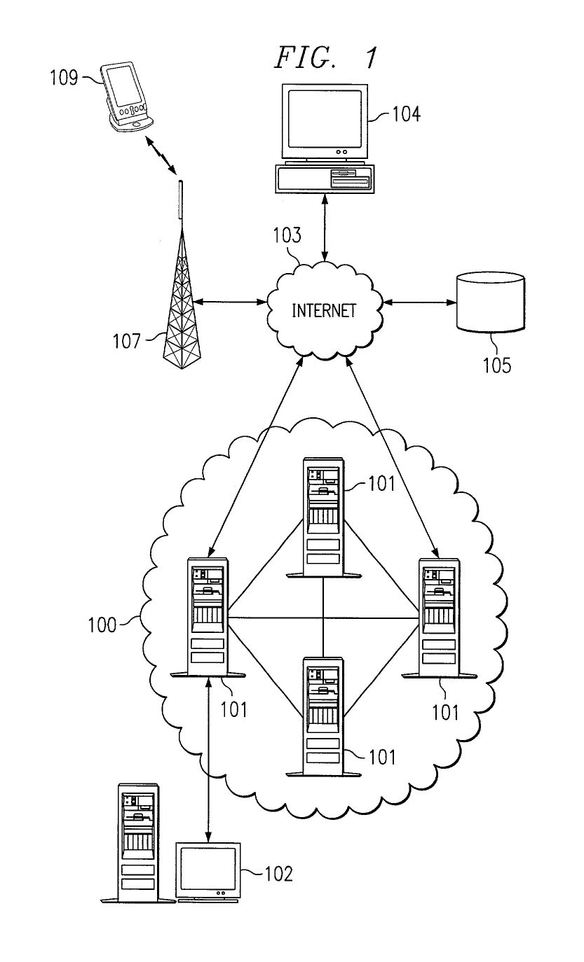

FIG. 1 is a diagram of a system according to a preferred embodiment of the invention. A private real-time interactive service network 100 (e.g., WEBEX) comprises a plurality of nodes 101 interconnected by appropriate communication links. Nodes 101 may include appropriate computer platforms and/or routers to support data transport. In addition to computing facilities provided by nodes 101, additional processing capabilities may be provided to augment network 100, either as part of the network or, as shown in FIG. 1, external to the network in the form of computer platform 102. Private real-time interactive services network 100 may include appropriate communication interfaces to Internet 103 and/or other networks (not shown) such as the public switched telephone network (PSTN), a wireless network, such as a personal communication services (PCS) network, and/or the like. Remote host computer 104 and database 105 may also be connected to network 100, such as via Internet 103.

Remote host computer 104 may comprise a typical home or office personal computer storing personal and/or user specific data and/or providing access to corporate information. Additionally or alternatively, host computer 104 may comprise a network of computers, such as a local area network (LAN), a wide area network WAN), and/or the like. Remote host computer 104 preferably provides for the execution of various routines, including application programs, utilities, and/or other services (herein collectively generically referred to as application programs) under supervision of an appropriate operating system such as WINDOWS 2000®. Database 105 may be interfaced to remote host computer 104 and may be independently available and accessible via a network, such as Internet 103, storing therein personal data of a user or other data which is processed by servers and rerouted to Internet 103.

Access to remote host computer 104 is preferably provided via light client in the form of, for example, local personal digital assistant (“PDA”) 109. PDA 109 may be connected to a network, such as Internet 103, via an appropriate communications facility to thereby facilitate communication with remote host computer 104. For example, wireless connectivity may be provided via wireless facilities 107 to interface local PDA 109. Such wireless connectivity may be provided using, for example, CDMA, CDPD, GSM, GPRS or any other form of wireless connection configured to transport data.

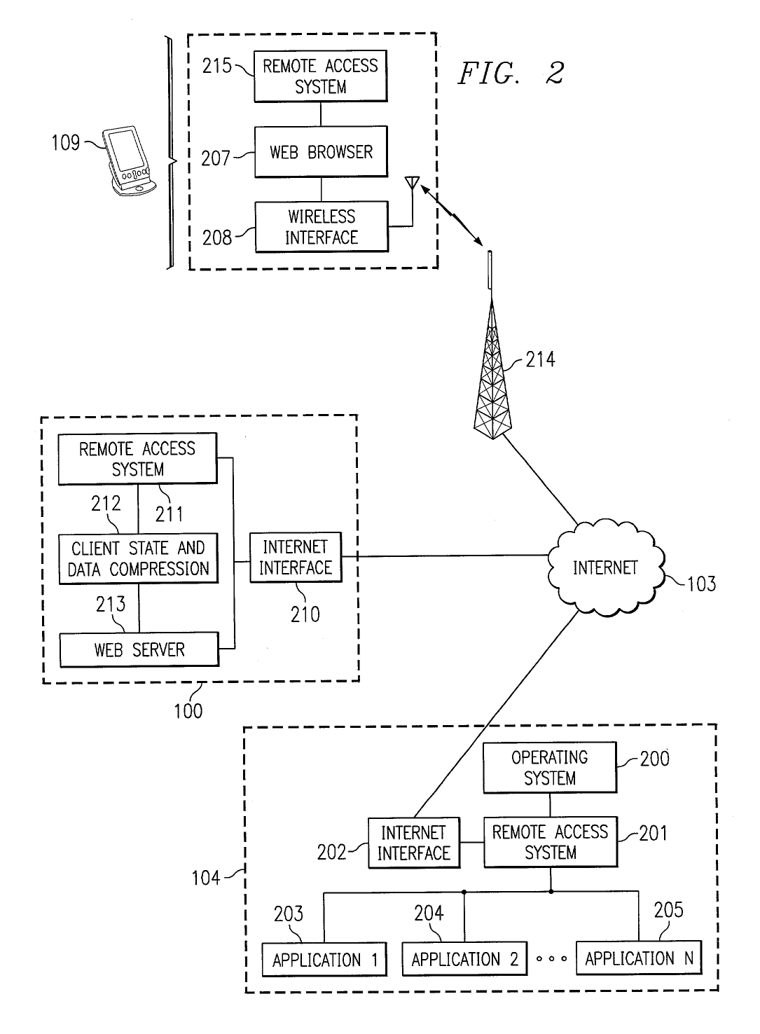

FIG. 2 is a diagram of a preferred embodiment of the invention including block diagrams of remote host computer 104, elements of PDA 109 and support functionality supplied by intermediate network node facilities in the form of computer platform 100. As shown, remote host computer 104 of the preferred embodiment includes an operating system 200 running a remote access system 201. The remote access system functionality provided by remote access system 201 (and 211, as will be discussed below) may be similar to existing software such as, for example, PCANYWHERE® or the remote control systems previously mentioned or its functional equivalent. Remote host computer 104 may further include a network interface, shown here as Internet interface 202, providing connectivity between remote access system 201 and a network, here Internet 103. Also stored and executed by remote host computer 104 of the illustrated embodiment are applications 203, 204, and 205 representing any number of software routines as previously described and including, for example, word processing, database management, spreadsheet programs, helper applications, graphics programs, accounting programs, personal information management programs, etc.

A private real-time interactive services network 100 including a network interface, shown here as Internet interface 210, supporting remote access system 211, which preferably interfaces with remote access system 201 is also preferably connected to the network, here as Internet 103. Real-time interactive services network 100 of the preferred embodiment supports remote functionality requirements at a point intermediate to remote host computer 104 and PDA 109, thereby functioning as an intermediate network node. Thus, remote access system 211 and 201 work together to provide remote control of selected ones of applications 203, 204, and 205 by PDA 109. PDA 109 preferably displays the information provided by a selected application. The information being transmitted by remote access system 201, to remote access system 211, then from remote access system 211 to remote access system 215 for display or PDA 109. Correspondingly, information from PDA 109 is preferably transmitted from remote access system 215 to remote access system 211 and then from remote access system 211 to remote access system 201 to the selected application program.

Client state and data compression subsystem 212 of the illustrated embodiment of real-time interactive services network 100 preferably interfaces remote access system 211 to web server 213. To facilitate intermediate remote control operation according to the preferred embodiment, client state and data compression subsystem 212 maintains the state of the PDA display (e.g., the display being viewed by the user) and performs appropriate data conversion and compression so as to accommodate use of PDA 109 with selected programs and/or to minimize transmission bandwidth required when transmitting update information to the local terminal representing the display output provided by a selected application. The display may be provided in a preferred target format such as an HTML web page hosted by web server 213 although other formats may be used as supported by remote access systems 215. Other transport may also be used including, for example, other forms of compression compatible with or in addition to HTML, for example, TIFF, JPEG, GIF, MPEG, and other image formats in addition to conventional text files supported by HTML or similar mark-up language (e.g., XML.) Web server 213 is preferably interfaced to the network, here Internet 103, via Internet interface 210.

PDA 109 interfaces to the network, here Internet 103, using conventional network means. For example, PDA 109 includes a web browser 207, which may connect to Internet 103 via a conventional wireless interface 208. Also provided on PDA 109 of the illustrated embodiment is remote access system 215 which may be preinstalled, downloaded from web server 213 upon initiation of a remote access session, or otherwise obtained. Remote access system 215 preferably provides two-way communications with remote access system 211 of private real-time interactive services network 100. Remote access system 211 may further support any other functionalities utilized in interfacing with and support access to remote access system 201 via remote access system 211 including, for example, display functions, decoding and communications, control signaling, etc.

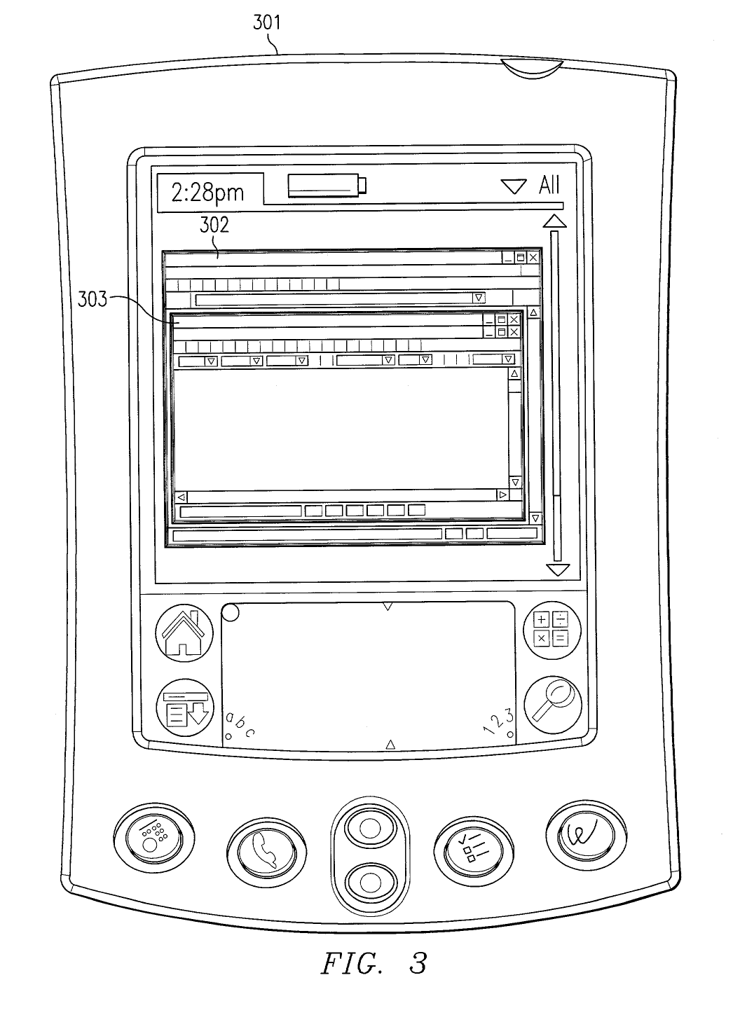

FIG. 3 is a front view of a handheld display 301 as might be used in combination with a PDA platform such as PDA 109. Displayed on handheld display 301 is a suitable client such as web browser display 302 providing access to the Internet and intermediate facilities supporting web server 213 (FIG. 2). A web page generated by the web server, in this case a Microsoft® Word® application running on the remote host computer may be displayed within the web browser display 302 or directly displayed to the screen. Using the downloaded remote access system 215, commands input by the user of the local system are transmitted to the web server. In turn, the web server translates the inputs and supplies it to client state and data compression subsystem 212 to be passed onto remote access system 211. The upstream transmission of commands is completed by transmission of the commands to remote access system 201 and to the activated application.

Displayable information generated by a particular application is interfaced in the downstream direction to remote access system 201 and transmitted to remote access system 211 at the intermediate network node facility where it is translated into appropriate HTML or other format supported by the remote systems such as a web page hosted by web server 213. In turn, web browser 207, as displayed in web browser display 302 of FIG. 3, decodes the HTML (for example) and provides a virtual image of the display able information, in this case, a Microsoft® Word® window 303.

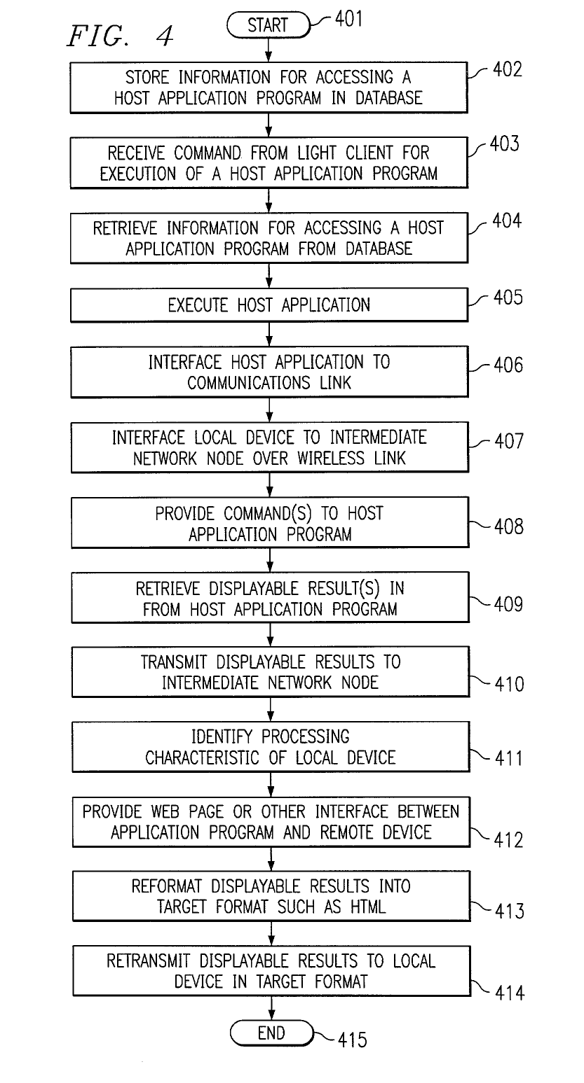

A method according to an embodiment of the invention is now detailed in connection with FIG. 4. Beginning at step 401, information for accessing a host application program (such as applications 203-205) is stored in a database at step 402 of the method. The database may be a separate database such as database 105 as shown in FIG. 1, or a database resource associated with nodes 101 or other components of interactive service network 100 as shown in FIG. 2 of the drawings. At step 403 a command is received from a light client for execution of a host application program, such as one of applications 203-205. The light client may include, for example, PDA 109 as shown in FIG. 2. In response to the command, at step 404 information for accessing a host application program resident on, for example, remote host computer 104 is retrieved from the appropriate database consistent with step 402. Once identified, the host application is executed on the appropriate platform, e.g., on remote host computer 104, at step 405. At step 406 an interface is established with the host application program via a communications link such as, for example, Internet 103. The communication link provides a connection between interactive service network 100 forming an intermediate network node and remote host computer 104 executing the selected host application program. An interface is also created at step 407 to provide communications between a local device, such as PDA 109, and the intermediate network node, such as interactive service network 100, preferably over a wireless link according to one embodiment of the invention. The wireless link may be the aforementioned CDMA, CDPD, GSM or GPRS link or equivalent wireless facilities 107 depicted in FIG. 2.

Referring back to FIG. 4, commands received from the local device (e.g., PDA 109) are provided to the selected host application program 203-205, as appropriate, at step 408. In response, the selected host application program performs appropriate processing to provide an output in the form of some displayable results. At step 409, these displayable results are retrieved from the host application program and, at step 410, are transmitted to the intermediate network node from remote host computer 104 (FIG. 2). At step 411, processing characteristics of the local device (e.g., PDA 109) are identified so as to provide an appropriate interface, including any required conversion of the displayable results, so as to accommodate display of the displayable results on the local device. At step 412, consistent with a preferred embodiment of the present invention, a web page type format or other suitable interface is provided between the application program and the remote device, the web page supported by interactive service network 100 and, more particularly, web server 213. Further processing to support the interface may be accomplished at step 413 which reformats the displayable results into a format compatible with the target local device such as HTML. Upon completion of the conversion process, the displayable results are retransmitted by the intermediate network node to the local device in the selected target format at step 414, the method terminating at step 415.

What is claimed is:

1. A system for providing access to computer resources from a light client, said system comprising:
a host computer platform including (i) an application program configured to interact with a user to provide displayable results and (ii) a host routine configured to interface said application program to a communications link; and
a server including (i) a remote routine configured to interactively interface with said host routine on said communications link to provide remote access to said application program, and (ii) a remote access hosting routine configured to provide said displayable results in a form displayable by said light client and to retransmit commands from said user to said application program via said remote routine.

2. The system according to claim 1 wherein said remote access hosting routine further comprises an HTML server.

3. The system according to claim 1 further comprising a local area network including a plurality of routers and configured to provide communications between said server and the Internet.

4. The system according to claim 1 further comprising a local device, comprising said light client, configured to access said server and retrieve said displayable page from and provide said commands to said remote access hosting routine.

5. The system according to claim 4 wherein said local device includes an HTML client.

6. The system according to claim 1 further comprising a wireless communications system configured to interface said server with said user.

7. The system according to claim 1 further comprising a database accessible by said user and configured to store information for accessing said host computer platform.

8. The system according to claim 1 wherein said web page hosting routine is responsive to a display property of a remote client for formatting said displayable page.

9. The system according to claim 1 further comprising a local area network including a plurality of nodes interconnected by a communications network, at least one of said nodes comprising said server and at least one of said nodes accessible by a remote device using a wireless communication link.

10. A method of providing access to computer resources from a light client comprising the steps of:
receiving a command from a light client for execution of a host application program;
executing said host application program to provide displayable results;
interfacing said host application program to a communications link;
transmitting said displayable results to an intermediate network node;
reformatting said displayable results into a target format; and
retransmitting said displayable results in said target format to said local device.

11. The method according to claim 10 wherein said step of reformatting includes a step of translating said displayable results into an HTML format.

12. The method according to claim 10 wherein said step of reformatting includes a step of hosting a web page.

13. The method according to claim 10 further comprising steps of retrieving said displayable result in said target format as a displayable page from and providing commands to said host application program via said intermediate network node.

14. The method according to claim 10 further comprising a step of interfacing said intermediate network node to said local device over a wireless communications link.

15. The method according to claim 10 further comprising a step of storing information for accessing said host application program in a database.

16. The method according to claim 10 further comprising step of identifying a processing characteristic of said local device and, in response, performing said step of reformatting so as to provide a compatible interface between said application program and said remote device.

17. A system for providing remote access to computer resources comprising:
hosting means including (i) processing means configured to interact with a user to provide displayable results and (ii) local interface means for interfacing said processing means to a communications link; and
server means including (i) a remote interface means configured to interactively interface with said local interface means on said communications link to provide remote access to said processing means, and (ii) a remote access hosting means configured to provide said displayable results in the form of a displayable page and to retransmit commands from a user to said processing means via said remote interface means.

18. The system according to claim 1 wherein said web page hosting means further comprises an HTML server.

19. A server for providing access to computer resources on a host computer platform from a light client, said server comprising:
a remote routine configured to interactively interface with a host routine resident on the host computer platform to provide remote access to an application program resident on the host computer platform; and
a remote access hosting routine configured to provide displayable results in a form displayable by the light client and to retransmit commands from a user to said application program via said remote routine.

20. The server according to claim 19 wherein said remote access hosting routine further comprises an HTML server.
